(19) United States
(12) Patent Application Publication
(10) Pub. No.: US 2020/0268030 A1
(43) Pub. Date: Aug. 27, 2020

(54) COMPOSITION FOR FOOD TEXTURISATION

(71) Applicants: Nicolas PERRENOUD, Lausanne (CH); Gabriel SERERO, Lausanne (CH); Julien LEROUXEL, Lausanne (CH); Jean-Marc TENDON, Hauteville (CH)

(72) Inventors: Nicolas PERRENOUD, Lausanne (CH); Gabriel SERERO, Lausanne (CH); Julien LEROUXEL, Lausanne (CH); Jean-Marc TENDON, Hauteville (CH)

(21) Appl. No.: 16/651,148

(22) PCT Filed: Sep. 12, 2018
(86) PCT No.: PCT/IB2018/056963

§ 371 Date: Mar. 26, 2020

(30) Foreign Application Priority Data
Sep. 27, 2017 (IB) PCT/IB2017/055884

(51) Int. Cl. A23L 29/256; A23L 29/238; A23L 29/269; A23L 29/244

(52) U.S. Cl. CPC A23L 29/256; A23L 29/238; A23L 33/40; A23L 29/244; A23L 29/27

(57) ABSTRACT

The invention relates to a sterilised composition for texturising reconstituted foods, comprising a mixture of texturising agents, water, and a mixture of thickeners and gelling agents.

### CORRESPONDING APPLICATIONS

The present application claims the priority of the earlier international application No. PCT/IB2017/055884 filed on Sep. 27, 2017, the contents of that earlier application being incorporated by reference in its entirety in the present application.

### FIELD OF THE INVENTION

The invention is in the field of foods and more precisely the texturizing of solid or semi-solid foods.

### PRIOR ART

Dysphagia is a disorder of food transit in the upper digestive system (mouth and esophagus). People who suffer from it, mostly the elderly, have difficulty swallowing.

This disorder can result in a significant loss of appetite in people affected, the consequences of which can lead to a state of undernutrition such that the people's lives are at risk.

Swallowing can be made easier by making the food into a puree, but in that case the food is less appetizing and its flavors are reduced or even eliminated.

There is therefore a need to offer people with dysphagia reconstituted food preparations whose appearance is attractive and flavors are preserved, while also retaining moisture, thus making swallowing easier.

### DESCRIPTION OF THE INVENTION

First, the invention relates to a sterilized composition for texturizing foods comprising a mixture of texturizers, water, agar and a mixture of thickeners and gelling agents.

According to an embodiment, the composition is obtained by the following process:
Cold addition of a mixture of texturizers to water,
Addition of a mixture of thickeners and gelling agents and keeping the assembly in suspension,
Packaging in an airtight package,
Sterilization, homogenization, cooling and quarantining.

Preferably, one of the texturizers is agar.

According to a particularly advantageous variant of the invention, the composition includes the following ingredients: agar, xanthan, carob, guar and konjac.

Preferably, the composition according to the invention can be stored at room temperature.

The invention also covers any food comprising the aforementioned composition, as well as the process described above.

Finally, the invention covers any use of the aforementioned composition for texturizing reconstituted foods.

The composition according to the invention can be advantageously used for texturizing foods whose texture falls within categories 3 to 7 of the IDDSI (International Dysphagia Diet Standardisation Initiative) classification of foods.

The composition according to the invention is preferably vegan and gluten-free.

The pre-gelatinization of the composition according to the invention provides a high shear resistance of the product, which can then be cut, grated or mixed and blended to be incorporated into a mass of food previously reduced to a puree.

The heating of the mixture of food+composition according to the invention, after cooling, makes it possible to obtain a setting in mass, the assembly being finally textured.

The composition according to the invention can be used in different ways, for all types of foods, both hot and cold. It can also be enriched with proteins.

During heat regeneration the textured assembly can be heated to 85° C. and then remain stable for about 5 hours.

The composition according to the invention offers the advantage of restoring an appetizing texture to any type of preparation and of easily adapting the hardness of the final product to the person's needs.

An example of the process for manufacturing the composition according to the invention is shown in the FIGURE.

A few examples of a composition according to the invention are described below:

### Example 1

agar (type 2) 39%, xanthan 21.1%, carob 14%, guar 13.3%, konjac 12.6%

### Example 2

agar (type 2) 65%, xanthan 9.6%, carob 8.7%, guar 6.9%, konjac 9.8%

### Example 3

agar (type 1 nikan 5%) 52.6%, xanthan 23.5%, carob 13.2%, guar 6.4%, konjac 4.3%

### Example 4

agar (type 1 nikan 0.5%) 60.8%, xanthan 19.5%, carob 10.9%, guar 5.25%, konjac 3.55%

The texturizers are in powder form. Each ingredient is precisely dosed in a packaging designed for the production batch size.

These percentages and ingredients may vary. Preferably, the percentage of the mixture of texturizers is greater than 6%.

At room temperature the composition according to the invention is a solid gel with mechanical properties.

Various studies and observations were made in people with dysphagia. They show that with foods textured with the composition according to the invention, the return rate of empty plates is considerably higher compared with commonly served foods.

1. A sterilized composition for texturizing reconstituted foods comprising a mixture of texturizers, water, and a mixture of thickeners and gelling agents.

2. The composition as claimed in claim 1 obtained by the following process:
Cold addition of a mixture of texturizers to water,
Addition of a mixture of thickeners and keeping the assembly in suspension,
Packaging in an airtight package,
Sterilization, homogenization, cooling and quarantining.

3. The composition as claimed in claim 1 wherein one of the texturizers is agar.

4. The composition as claimed in claim 3 comprising the following ingredients: agar, xanthan, carob, guar and konjac.

5. The composition as claimed in claim 1 wherein the mixture of texturizers is between 6 and 35% of the total weight of the composition.

6. The composition as claimed in claim 5 wherein the mixture of texturizers constitutes about 15% of the weight of the mixture of texturizers/water assembly.

7. The composition as claimed in claim 1, wherein at room temperature it is in solid form with mechanical properties.

8. The composition as claimed in claim 1, which once incorporated into a food preparation makes it possible, depending on the amount added, to obtain a very wide range of textures and rheological values according to need.

9. A food preparation comprising a composition as claim 1.

10. A process for manufacturing a composition as defined in claim 1, the process comprising the following steps:
Cold addition of a mixture of texturizers to water,
Addition of a mixture of thickeners and keeping the assembly in suspension,
Packaging in an airtight package,
Sterilization, homogenization, cooling and quarantining.

11. The use of the composition as defined in claim 1 for texturizing reconstituted foods.

12. The use as claimed in claim 11 wherein the composition is melted or cut, grated, mixed before incorporation into the food.
